(19) United States
(12) Patent Application Publication
(10) Pub. No.: US 2026/0329768 A1
(43) Pub. Date: Oct. 22, 2026

(54) DYNAMIC MEMORY REMAPPING FOR MANIFOLD-CONSTRAINED RESIDUAL LANES IN NEURAL NETWORK SYSTEMS

(71) Applicant: Dorian Cartwright, San Jose, CA (US)

(72) Inventor: Dorian Cartwright, San Jose, CA (US)

(21) Appl. No.: 19/658,054

(22) Filed: Apr. 24, 2026

(51) Int. Cl. G06F 12/06

(52) U.S. Cl. CPC G06F 12/063; G06F 2212/206

(57) ABSTRACT

A computing system includes a memory, a processor, and a memory controller configured to manage physical storage of residual lanes associated with a neural-network layer. The memory controller stores a plurality of residual lanes in physical memory according to a first lane-to-address mapping, obtains lane-state information from a manifold-constraining projection applied to an inter-lane mixing structure, and generates a second lane-to-address mapping based on one or more identified lane relationships among the residual lanes. The second lane-to-address mapping at least one of compacts, aliases, merges, migrates, or releases physical storage associated with one or more residual lanes. Subsequent memory accesses for the plurality of residual lanes are controlled according to the second lane-to-address mapping. The disclosed techniques reduce memory footprint, bandwidth demand, and inefficient storage of residual information while preserving logical accessibility for downstream neural network operations.

### FIELD OF THE INVENTION

The present disclosure relates generally to computers and physical artificial intelligence (AI), and more specifically, to dynamically remapping physical memory allocated to residual lanes of a neural-network layer based on lane relationships identified from a manifold-constraining projection applied to an inter-lane mixing structure.

### BACKGROUND

Modern neural network architectures, including transformer-based architectures, state-space architectures, mixture-of-experts architectures, multimodal models, and other large-scale machine-learning systems, increasingly rely on high-dimensional intermediate representations that propagate through many successive layers. In many such systems, a residual representation is carried forward from layer to layer, optionally combined with newly computed information, and repeatedly read from and written to memory during training and inference.

As model size, sequence length, and batch complexity increase, the storage and movement of intermediate activations and residual representations impose substantial burdens on physical memory capacity, memory bandwidth, power consumption, and thermal budget. This burden is especially pronounced in high-performance environments employing graphics processing units, neural processing units, tensor accelerators, or other specialized processors coupled to high-bandwidth memory, SRAM, DRAM, or tiered storage hierarchies.

Conventional memory systems generally store residual dimensions or lanes according to static, dense allocation policies. Under such approaches, logical dimensions of a residual tensor are assigned fixed or predetermined physical addresses, and memory transactions proceed as though all lanes remain independently material and equally worthy of storage throughout execution. However, in many neural network computations, the effective degrees of freedom of a residual representation are reduced by one or more transformations that constrain the representation to a lower-dimensional manifold or otherwise induce structured relationships among lanes.

For example, an attention output projection, feed-forward projection, bottleneck layer, learned mask, pruning operator, low-rank transform, gating structure, normalization-adjacent transform, or related inter-lane mixing structure may cause one or more lanes to become zeroed, linearly dependent, redundant, correlated, reconstructible from other lanes, or otherwise less deserving of dedicated storage. Despite this algorithmic reality, conventional memory controllers generally continue to reserve separate physical storage for all lanes, thereby wasting capacity, increasing read and write traffic, and reducing efficiency.

Existing compression or sparsity techniques are often implemented at the software or model-design level and may not directly control hardware-visible lane-to-address mappings. Likewise, generic paging systems may move blocks of memory without regard to lane relationships induced by model structure. As a result, there remains a need for a memory-management architecture that can respond directly to manifold-constraining behavior in neural network computation and alter physical storage treatment of residual lanes while preserving a software-visible logical tensor interface.

Accordingly, there exists a need for systems and methods in which a memory controller receives lane-state information derived from a manifold-constraining projection applied to an inter-lane mixing structure and, based on such lane-state information, dynamically generates an updated lane-to-address mapping that compacts, aliases, merges, migrates, or releases physical storage associated with one or more residual lanes.

### SUMMARY

These shortcomings are addressed by systems, methods and computer program products for dynamic memory remapping of residual lanes in neural network systems.

In one embodiment, a computing system includes a memory, a processor, and a memory controller. The memory controller is configured to receive data representing a plurality of residual lanes of a neural-network layer and store the plurality of residual lanes in physical memory according to a first lane-to-address mapping. The memory controller is further configured to obtain, from a manifold-constraining projection applied to an inter-lane mixing structure, lane-state information identifying at least one lane relationship among the plurality of residual lanes. Based on the lane-state information, the memory controller generates a second lane-to-address mapping that at least one of compacts, aliases, merges, migrates, or releases physical storage associated with one or more of the residual lanes. Subsequent memory accesses for the plurality of residual lanes are then controlled according to the second lane-to-address mapping.

In some embodiments, the lane-state information identifies zeroed lanes, masked lanes, linearly dependent lanes, correlated lanes, aliased lanes, reconstructible lanes, low-priority lanes, low-variance lanes, low-entropy lanes, inactive lanes, or combinations thereof.

In some embodiments, generating the second lane-to-address mapping includes releasing storage for one or more zeroed lanes, aliasing a logical lane to a physical address used by another lane, compacting sparse or active lanes into a smaller contiguous region, merging plural lanes into a shared backing structure, or migrating selected lanes to a different memory tier.

In some embodiments, subsequent memory requests are serviced in a manner that preserves a logical tensor view visible to downstream neural network operations, even though the underlying physical storage arrangement has changed. Reconstruction may include zero insertion, alias resolution, decompression, transform-based derivation, or retrieval from another memory tier.

In some embodiments, remapping decisions are made based on one or more policy criteria including memory pressure, bandwidth pressure, predicted lane reuse, reconstruction cost, quality-of-service constraints, thermal conditions, or downstream sensitivity.

These and other aspects, embodiments, and advantages of the present disclosure will be apparent from the following detailed description and accompanying claims.

### BRIEF DESCRIPTION OF THE DRAWINGS

The present disclosure will be understood more fully from the detailed description given below and from the accompanying drawings of various embodiments of the disclosure.

FIG. 1 is a block diagram illustrating a processor driven AI computing environment, according to an embodiment.

FIG. 2 is a block diagram illustrating interactions between tiered memory of FIG. 1, according to an embodiment.

FIG. 3 is a more detailed block diagram of first lane to address mapping of FIG. 2, according to an embodiment.

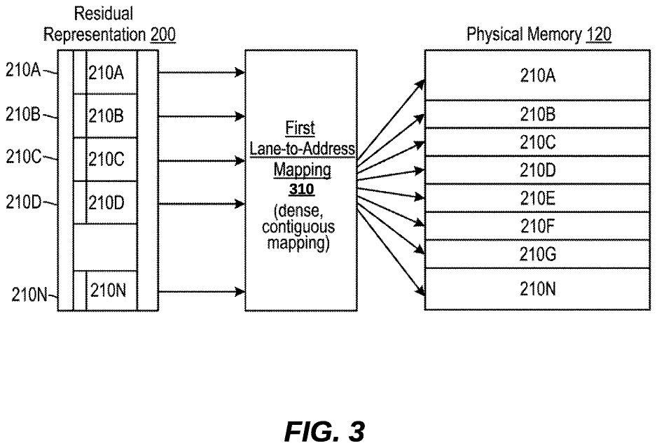

FIG. 4 is a more detailed block diagram of lane-state information generated for a memory controller of FIG. 2, according to an embodiment.

FIG. 5 is a more detailed block diagram of second lane-to-address mapping for the memory controller of FIG. 2, according to an embodiment.

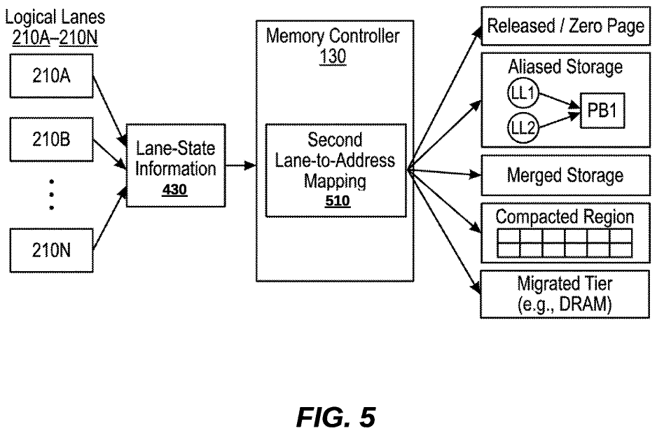

FIG. 6 is a flow chart illustrating a method for dynamic memory remapping of residual lanes in neural networks, according to an embodiment.

### DETAILED DESCRIPTION

The present disclosure provides systems, methods, and computer program products for a hardware-oriented memory-management architecture for neural network systems in which physical storage treatment of residual lanes is dynamically modified based on relationships identified from a manifold-constraining projection associated with an inter-lane mixing structure.

For purposes of the present disclosure, a “residual lane” may refer broadly to a channel, dimension, slice, partition, vector component, subspace, grouped feature set, tokens-by-feature block, or other logical subdivision of a neural network representation. An “inter-lane mixing structure” may refer broadly to any operator, layer, transformation, or computational structure that mixes, suppresses, gates, correlates, prunes, projects, or otherwise alters relationships among a plurality of residual lanes. A “manifold-constraining projection” may refer to any transformation, condition, operator, metadata description, or runtime-determined property indicating that the effective degrees of freedom of a residual representation are reduced relative to a nominal lane count or that one or more lanes bear structured relationships to one another.

The disclosed techniques may be applied during inference, training, checkpointing, activation storage, rematerialization support, cache management, or other stages of neural network execution. The disclosed techniques may be implemented in hardware, firmware, microcode, software, or any combination thereof, although certain embodiments emphasize operation by a memory controller positioned at or below a hardware-software boundary.

In some embodiments, the functions described herein may be implemented as separately claimable subcombinations. For example, a lane-state analyzer, lane-state descriptor generator, remap-policy engine, lane-to-address map update unit, logical-tensor reconstruction engine, tier-placement engine, accounting module, fallback-map controller, compiler metadata interface, or runtime metadata interface may be implemented independently or in combination with other disclosed components. Accordingly, although certain embodiments describe a memory controller performing multiple functions, any subset of the disclosed lane-state derivation, remapping, reconstruction, tiering, policy, accounting, or metadata-interface functions may be practiced by hardware logic, firmware, a driver, a compiler, a runtime, a scheduler, a service processor, a memory hub, a chiplet controller, or another control component.

### I. Systems for Dynamic Memory Remapping of Residual Lanes in Neural Networks

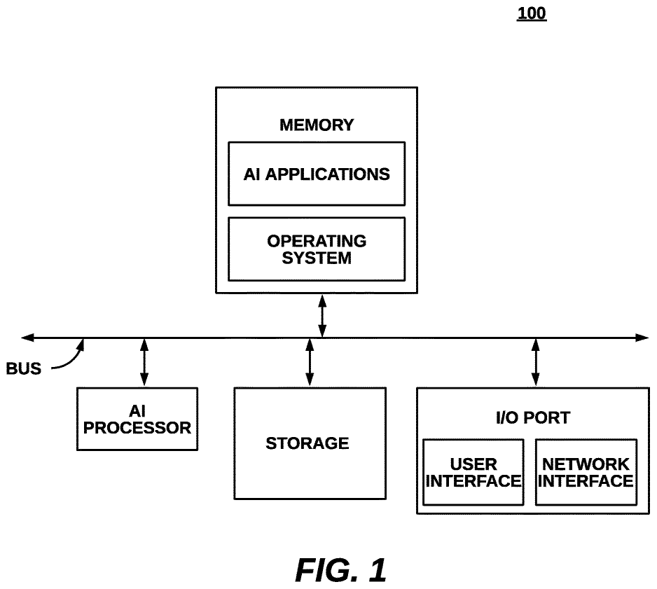

Referring to FIG. 1, an example computing system 100 may include one or more processors 110, one or more memories 120, and a memory controller 130. The processor 110 may include, for example, a CPU, GPU, NPU, TPU, AI accelerator, tensor processor, vector processor, DSP, or any combination thereof. The memory 120 may include on-chip SRAM, cache memory, HBM, DRAM, persistent memory, storage-class memory, NVRAM, SSD-backed swap, remote memory, or combinations thereof.

In some embodiments, the memory controller 130 is implemented as dedicated hardware logic integrated within an accelerator package, memory hub, system-on-chip, chiplet arrangement, memory expander, memory interface device, or near-memory processing structure. In other embodiments, the memory controller 130 includes firmware-controlled circuitry, a controller microengine, a service processor, a DMA-associated remapping engine, programmable logic, driver-controlled logic, or a combination thereof. The memory controller 130 may communicate with execution units, cache systems, DMA engines, interconnect fabrics, compiler metadata sources, runtime metadata sources, graph schedulers, model-serving runtimes, or operating-system memory managers. In some embodiments, the memory controller 130 includes or cooperates with a policy engine, descriptor-table store, remap table, reconstruction unit, tier-placement unit, accounting unit, and fallback-map unit.

The memory controller 130 may operate as an intermediary between the processor 110 and the memory 120 to control storage, retrieval, remapping, reconstruction, and movement of data representing residual lanes.

In some embodiments, the memory controller 130 maintains one or more lane descriptor tables associated with logical residual lanes or lane groups. A lane descriptor table entry may include a logical lane identifier, lane-group identifier, physical address, physical page identifier, memory-tier identifier, bank identifier, cache-line range, mapping state, remapping action, parent-lane identifier, shared-backing identifier, transform identifier, reconstruction mode, priority score, confidence score, validity interval, access frequency, predicted reuse value, dirty/clean state, ownership or namespace field, fallback-map pointer, or accounting field. The lane descriptor table may be stored in SRAM, controller-local registers, HBM metadata space, firmware-managed memory, host-visible memory, or a protected control region.

In some embodiments, the memory controller 130 updates the lane descriptor table atomically, transactionally, or using double-buffered map versions so that downstream execution units observe a consistent logical tensor view. A first map version may remain active while a second map version is prepared, validated, or partially populated. After validation, the memory controller 130 may switch to the second map version and retain the prior map version as a fallback map for replay, rollback, debugging, accuracy verification, or recovery from a reconstruction error.

### A. Residual Lanes and First Lane-to-Address Mapping

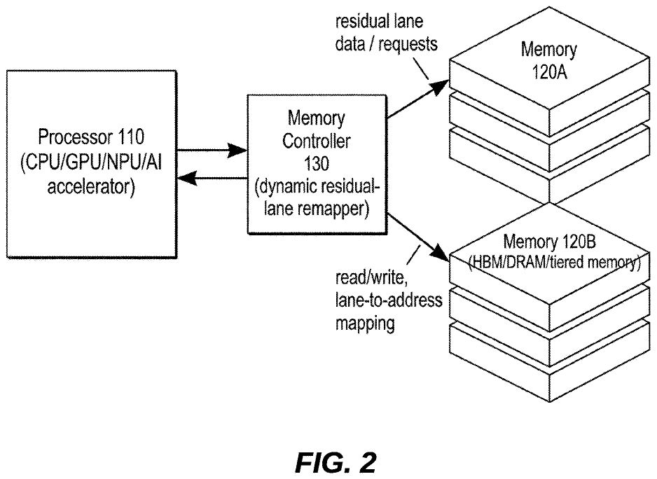

Referring to FIG. 2, a neural-network layer may generate or update a residual representation 200 having a plurality of residual lanes 210A-210N. In some embodiments, the residual representation may be modeled as a tensor having batch, sequence, and feature dimensions, where the feature dimension is treated as including the plurality of residual lanes.

Initially, the memory controller 130 may store the residual lanes 210A-210N in the memory 120 according to a first lane-to-address mapping 220. The first lane-to-address mapping 220 may be dense and contiguous, such that each logical lane index corresponds to a distinct physical address range. In other embodiments, the first lane-to-address mapping 220 may reflect predetermined striping, banking, interleaving, paging, tiling, cache-line alignment, or similar physical storage constraints.

Under conventional operation, such a first mapping might remain fixed for subsequent accesses. In the present disclosure, however, the first lane-to-address mapping 220 may be modified when lane-state information indicates that one or more lanes no longer warrant separate physical treatment.

### B. Inter-Lane Mixing Structure and Manifold-Constraining Projection

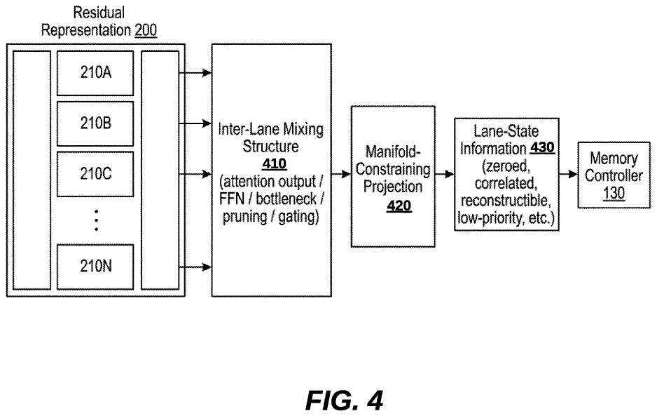

Referring to FIG. 4, the residual representation 200 may be processed by an inter-lane mixing structure 410. The inter-lane mixing structure 410 may include, by way of example and not limitation, an output projection of an attention block, a feed-forward projection, a bottleneck layer, a learned mask, a pruning operator, a low-rank transform, a gating operator, a normalization-adjacent transform, a compression operator, a latent mixing layer, or another structure that influences relationships among lanes.

A manifold-constraining projection 310 may be applied by, associated with, or inferred from the inter-lane mixing structure 300. In some embodiments, the manifold-constraining projection 310 explicitly maps a higher-dimensional representation to a lower-dimensional manifold. In other embodiments, the manifold-constraining projection 310 may be represented implicitly by model metadata, runtime statistics, threshold behavior, structural rank, sparsity patterns, covariance patterns, correlation scores, singular value estimates, reconstruction criteria, or other indicators that fewer than all logical lanes contain independent or separately material information.

In transformer-based embodiments, the inter-lane mixing structure 410 may correspond to an attention output projection, feed-forward network projection, residual-stream projection, multi-head attention output, grouped-query attention output, multi-query attention output, normalization-adjacent transform, adapter layer, low-rank adaptation layer, router, or mixture-of-experts gating structure. In state-space embodiments, the inter-lane mixing structure 300 may correspond to a scan, recurrence, convolutional state update, or state projection that induces dependency among channel groups or state components. In diffusion, multimodal, graph, recurrent, or convolutional embodiments, the inter-lane mixing structure 410 may correspond to a U-Net block, cross-modal fusion layer, graph message-passing operator, recurrent state update, channel-mixing operator, or other layer that causes selected lanes to be zeroed, correlated, dependent, reconstructible, low-priority, or otherwise suitable for altered physical storage treatment.

The memory controller 130, or associated logic cooperating therewith, obtains lane-state information 430 from the manifold-constraining projection 420. The lane-state information 430 identifies at least one lane relationship among the plurality of residual lanes.

### C. Lane-State Information

The lane-state information 430 may identify any one or more lane relationships useful for modifying physical storage treatment. Example lane relationships include, without limitation: a zeroed lane; a nearly zeroed lane; a masked lane; a linearly dependent lane; a correlated lane; an aliased lane; a duplicate lane; a reconstructible lane; a low-variance lane; a low-entropy lane; a low-priority lane; a low-significance lane; an infrequently accessed lane; a lane that may be derived from another lane or lane group according to a defined transform; a lane that should share physical backing storage with another lane; and combinations thereof.

In some embodiments, lane-state information 320 further includes a safety, trust, provenance, policy-risk, or content-risk state associated with one or more residual lanes or lane groups. Such a state may be generated by a safety classifier, provenance checker, guardrail module, prompt-injection detector, hallucination-risk estimator, policy engine, or trusted-source validator. A lane or lane group may be tagged as trusted, untrusted, safety-critical, policy-sensitive, unsafe-feature-bearing, hallucination-risk-bearing, privacy-sensitive, or restricted.

Based on the safety, trust, provenance, policy-risk, or content-risk state, the memory controller 130 may generate a second lane-to-address mapping that isolates, demotes, zeros, releases, quarantines, encrypts, pins, or requires conservative reconstruction of selected lanes. For example, a lane group associated with untrusted or unsafe feature activations may be mapped to a quarantine region, prevented from aliasing with trusted lanes, released and replaced with a neutral value, or made available only to a verification block. In this manner, hardware-visible residual-lane memory treatment may enforce AI safety or output-governance constraints before downstream generation proceeds.

In one example, a first lane may be identified as zero-valued due to a mask, gating condition, activation behavior, pruning decision, or low-magnitude threshold. In another example, a second lane may be identified as sufficiently correlated with or linearly dependent upon a third lane such that a separate physical allocation is unnecessary. In another example, a group of sparse lanes may be identified as suitable for compaction into a smaller contiguous physical region. In another example, a low-priority lane may be migrated to a lower-bandwidth, higher-capacity memory tier.

Lane-state information 320 may be represented using metadata tables, bitmaps, sparse masks, indirection arrays, descriptor tables, dependency graphs, alias tables, merge-group tables, transform identifiers, reconstruction identifiers, priority scores, confidence values, validity durations, access counters, policy hints, or combinations thereof. Such lane-state information 320 may be generated, revised, or invalidated per layer, per block, per token, per tile, per channel group, per attention head, per expert, per sequence window, per batch item, per pass, at selected intervals, or in response to a trigger condition. Trigger conditions may include a rank-reduction condition, sparsity condition, entropy threshold, variance threshold, norm threshold, reconstruction-error threshold, lane reuse prediction, memory-capacity condition, bandwidth-pressure condition, thermal condition, fragmentation condition, latency target, quality-of-service constraint, or confidence threshold.

In some embodiments, lane-state information 430 is generated by the memory controller 130. In other embodiments, lane-state information 430 is generated by a compiler, runtime, scheduler, model graph analyzer, kernel launcher, device driver, accelerator firmware, or model-serving system and provided to the memory controller 130 as hardware-consumable metadata. Such metadata may be encoded as a sideband descriptor, kernel launch annotation, graph-level attribute, tensor-layout annotation, memory-allocation attribute, page-table extension, command-buffer entry, or instruction-stream field.

In some embodiments, the memory controller 130 or an associated predictor tracks lane reuse histories across layers, token windows, recurrent steps, state-space scan intervals, video frames, multimodal time windows, or agentic trajectories. The predictor may determine that a residual lane or lane group is likely to be reused by a future layer, future token window, future branch, or future modality. Based on the prediction, the memory controller 130 may pre-build a second lane-to-address mapping, pre-compact selected lanes, prefetch migrated lanes, pre-migrate low-priority lanes, or pin high-priority lanes before the future access occurs.

In some embodiments, predictive remapping is performed using a future-access estimate derived from model structure, attention pattern, recurrent state, branch policy, token position, sequence length, runtime statistics, or historical lane-access traces. The memory controller 130 may revise the second lane-to-address mapping before a downstream operation requests the residual lanes, thereby reducing stalls associated with late migration, late reconstruction, or late compaction.

### D. Generation of Second Lane-to-Address Mapping

Referring to FIG. 4, based on the lane-state information 320, the memory controller 130 generates a second lane-to-address mapping 510. The second lane-to-address mapping 400 changes the physical storage treatment of one or more residual lanes while preserving the ability to satisfy subsequent logical accesses.

In some embodiments, the second lane-to-address mapping 400 is stored as a table, page-map extension, lane-map cache, descriptor array, indirection vector, compressed sparse mapping, graph of lane dependencies, or a combination thereof. The second lane-to-address mapping 510 may map a logical lane identifier to one or more of: a unique physical address range, shared physical address range, released-lane code, zero-generation code, alias target, transform rule, merge-group identifier, compacted-lane offset, alternate-tier address, remote-memory handle, reconstruction operator, or fallback mapping. In some embodiments, the second lane-to-address mapping 520 includes version information so that a downstream request can be resolved according to the map version that was active when the corresponding residual representation was produce.

In some embodiments, the second lane-to-address mapping 400 causes the controller to perform one or more of the following actions.

### 1. Release

If a lane is identified as zeroed, inactive, or otherwise unnecessary to store as unique data, the memory controller 130 may release physical storage associated with that lane. A subsequent read for that lane may be satisfied by a generated zero value, a shared zero page, or other synthesized response without reading released storage.

### 2. Alias

If a lane is identified as equivalent to, proportional to, or derivable from another lane, the second lane-to-address mapping 510 may alias a logical address of the first lane to physical storage associated with the other lane. In some embodiments, metadata may identify a scaling factor, transform, or reconstruction rule associated with the alias.

### 3. Merge

If a plurality of lanes share a joint representation or may be jointly encoded, the second lane-to-address mapping 510 may merge physical storage treatment of those lanes into a shared backing structure. Such shared backing structure may be accompanied by transform metadata sufficient for later reconstruction.

### 4. Compact

If a set of lanes is sparse, intermittently active, or identified as suitable for co-location, the controller may compact those lanes into a smaller contiguous region of physical memory. Compaction may improve locality, burst-transfer efficiency, cache-line utilization, and fragmentation characteristics.

### 5. Migrate

If one or more lanes are identified as low priority, infrequently reused, or less latency sensitive, the memory controller 130 may migrate those lanes from a first memory tier to a second memory tier having different bandwidth, latency, capacity, or cost characteristics. For example, selected lanes may be moved from SRAM or HBM to DRAM, persistent memory, or another tier.

In some embodiments, the second lane-to-address mapping 510 may also include flags or metadata indicating reconstruction mode, confidence level, validity duration, fallback behavior, or rollback availability.

In some embodiments, the second lane-to-address mapping 510 includes a current map and one or more fallback maps. The current map may be used during normal execution, while a fallback map may represent a prior dense mapping, less aggressive remapping, accuracy-preserving mapping, debugging mapping, replay mapping, or recovery mapping. The memory controller 130 may revert from the current map to a fallback map if a confidence score falls below a threshold, a reconstruction-error estimate exceeds a limit, a downstream sensitivity flag is asserted, a debugging mode is entered, a training-replay operation is requested, or an integrity-check operation detects a mismatch.

In some embodiments, map updates are performed in a policy-gated manner. The memory controller 130 may evaluate whether projected memory savings, bandwidth reduction, power reduction, or thermal reduction exceeds expected reconstruction cost, migration cost, latency penalty, accuracy-risk estimate, or map-update overhead before committing the second lane-to-address mapping 400.

### E. Subsequent Memory Accesses

When a downstream operation requests a logical residual representation, the memory controller 130 interprets the request according to the second lane-to-address mapping 400 rather than the first lane-to-address mapping 310.

In some embodiments, subsequent memory accesses may include one or more of: fetching a unique physical block for an independently stored lane; returning a generated zero value for a released lane; resolving an alias to shared physical storage; applying a stored transform to derive one lane from another lane or lane group; reconstructing a lane from merged storage; fetching a migrated lane from an alternate memory tier; inserting default values; expanding a compacted lane group into logical lane order; concatenating compacted lane groups into a logical view; retrieving a remote or peer-memory lane; or applying a decompression or reconstruction operator associated with the lane descriptor table.

In some embodiments, a lane group is stored using a codec selected based on lane-state information. Example codecs include block-floating-point coding, quantization, delta coding, low-rank basis coding, sparse coding, dictionary coding, entropy coding, predictive coding, residual coding, or error-bounded reconstruction coding. A lane descriptor may identify a codec type, scale factor, quantization parameter, basis identifier, dictionary identifier, error bound, reconstruction operator, or decompression location.

In some embodiments, reconstruction or decompression is performed by a near-memory reconstruction engine, HBM-stack logic, memory-side processing unit, SRAM-bank reconstruction unit, DMA-fused reconstruction unit, processing-in-memory unit, or tensor-core-adjacent reconstruction unit. The near-memory reconstruction engine may reconstruct a logical lane, lane group, or logical tensor view before data is delivered to a downstream compute unit, thereby reducing memory bandwidth or interconnect traffic associated with transferring unreconstructed physical representations.

In some embodiments, the memory controller 130 includes a logical-tensor reconstruction engine that receives a logical residual-lane request and produces a response having the logical lane order, tensor shape, and access semantics expected by a downstream neural-network operation. The reconstruction engine may perform alias resolution, zero insertion, default-value insertion, transform-based derivation, merge-group expansion, compacted-lane unpacking, alternate-tier retrieval, decompression, or combinations thereof before returning data to the requesting execution unit. The reconstruction engine may thereby preserve a software-visible logical tensor interface even though the underlying physical storage arrangement has been released, aliased, merged, compacted, migrated, or otherwise remapped.

In some embodiments, reconstruction is transparent to application software, model frameworks, kernels, graph-level logic, and model-serving logic. In other embodiments, selected software components cooperate with the memory controller 130 by providing hints, descriptors, projections, reconstruction operators, remappability annotations, tensor-layout annotations, policy annotations, or validity constraints. Such cooperation may permit a compiler or runtime to expose remappable residual-lane structure while the memory controller 130 performs hardware-visible address remapping and reconstruction.

### F. Example Tiered-Memory Embodiment

A tiered-memory embodiment may include a first memory tier and a second memory tier. The first memory tier may be higher bandwidth and lower latency, such as SRAM or HBM. The second memory tier may be lower bandwidth and higher latency, such as DRAM, storage-class memory, persistent memory, or remote/disaggregated memory.

Based on lane-state information, the memory controller 130 may retain higher-priority, higher-entropy, more frequently reused, latency-sensitive, or downstream-sensitive lanes in the first memory tier while migrating lower-priority, lower-entropy, infrequently reused, reconstructible, or less time-sensitive lanes to the second memory tier. The second lane-to-address mapping 400 may store the tier location, access policy, migration state, prefetch state, reconstruction mode, and fallback location for each logically addressed lane or lane group.

In some embodiments, the second lane-to-address mapping 400 includes a security domain, tenant identifier, session identifier, enclave identifier, trust label, or access-control label associated with a residual lane or lane group. The memory controller 130 may prevent aliasing, merging, shared-backing allocation, or compaction across incompatible security domains. The memory controller 130 may also require secure scrubbing, encryption, integrity verification, or namespace validation before a released physical region is reused by another tenant, session, model, or agent.

In some embodiments, lane-state information is combined with security labels to select a physical memory tier, bank, page, or remote memory region. For example, a high-priority lane belonging to a restricted tenant may remain in protected local HBM, while a low-priority lane belonging to an unrestricted session may be migrated to shared remote memory. A lane descriptor may include both a remapping state and a security state so that physical memory optimization does not cause cross-tenant leakage, side-channel exposure, or unauthorized aliasing.

In some embodiments, the first memory tier and second memory tier are located within a single accelerator package. In other embodiments, the memory tiers span on-chip SRAM, cache memory, HBM, DRAM, persistent memory, storage-class memory, host memory, peer accelerator memory, remote memory, or disaggregated memory. The memory controller 130 may select a tier based on lane priority, predicted reuse, reconstruction cost, bandwidth pressure, latency target, thermal condition, power budget, interconnect condition, or available capacity. In some embodiments, the memory controller 130 places selected lanes across local memory, peer memory, remote memory, or interconnect-aware storage resources while preserving a logical tensor view for downstream operations.

### G. Example Policy Logic

In some embodiments, remapping decisions are governed by a remap-policy engine. Example policy inputs include memory pressure, bandwidth pressure, thermal conditions, power budget, fragmentation metrics, predicted lane reuse, access frequency, reconstruction cost, migration cost, compression cost, confidence score, downstream sensitivity, service-level objective, latency target, model mode, training mode, inference mode, debugging mode, integrity mode, batch size, sequence length, token position, layer type, memory-bank utilization, interconnect congestion, and combinations thereof. The remap-policy engine may select among release, alias, merge, compact, migrate, reconstruct, retain, pin, prefetch, or fallback actions according to a multi-objective policy that balances memory savings, bandwidth reduction, latency, power consumption, thermal behavior, reconstruction overhead, and accuracy or fidelity risk.

In physical-AI embodiments, remapping decisions may further account for robot energy reserve, battery state, actuator thermal headroom, onboard processor thermal headroom, communication quality, network latency, offboard compute availability, safety-critical perception state, safety-critical planning state, tactile-contact state, localization confidence, or mission criticality. For example, residual lanes associated with obstacle avoidance, balance, manipulation safety, localization, or actuator planning may be pinned in local high-bandwidth memory, while residual lanes associated with lower-priority semantic reasoning, background summarization, or deferred planning may be compacted, migrated, or transferred to offboard or disaggregated memory.

In some embodiments, a physical AI platform includes an onboard processor and memory controller cooperating with an offboard memory or inference tier. The memory controller 130 may use lane-state information to determine whether residual lanes remain onboard, are migrated to a local lower-bandwidth tier, are transmitted to an edge gateway, or are stored in a remote memory pool. Such decisions may balance latency, safety criticality, communication quality, battery state, thermal headroom, and reconstruction cost.

The memory controller 130 may apply threshold logic, hysteresis, minimum residence times, confidence margins, map-versioning rules, rollback triggers, or oscillation-prevention rules to avoid unstable remapping. For example, a lane may be migrated only if a predicted reuse value remains below a threshold for a minimum interval; a compacted group may be unpacked only if reconstruction overhead exceeds a limit; and an alias may be retained only while a confidence margin associated with a dependency relation remains above a threshold. In some embodiments, the controller maintains both a current mapping and a fallback mapping to support error recovery, replay, debugging, retraining, quality assurance, or accuracy verification.

In some embodiments, the memory controller 130 maintains accounting data associated with remapping decisions. Accounting data may include memory saved, bandwidth avoided, power saved, thermal reduction, reconstruction overhead, migration frequency, compaction frequency, alias hit rate, released-lane read count, fallback frequency, confidence distribution, reconstruction-error estimate, downstream sensitivity, or quality-of-service impact. The remap-policy engine may use such accounting data to revise future remapping decisions, tune thresholds, select less aggressive remapping for sensitive layers, or select more aggressive remapping under memory pressure.

### H. Example Neural Network Embodiments

The disclosed techniques are not limited to transformer architectures. They may be applied to recurrent models, convolutional networks, graph neural networks, state-space models, diffusion models, encoder-decoder systems, multimodal architectures, mixture-of-experts models, and other machine-learning systems.

In one transformer embodiment, an attention output projection indicates that only a subset of residual lanes contributes independent information to a downstream block for a selected token window. The controller may therefore release storage for one or more zeroed lanes, alias one or more dependent lanes, compact selected active lanes into a contiguous HBM region, and migrate lower-priority lanes to DRAM.

In some embodiments involving agentic inference, a request or task may fork into a plurality of reasoning branches, tool-use branches, planning branches, verification branches, or candidate solution branches. The memory controller 130 may maintain a shared-root residual-lane mapping associated with state common to the branches and one or more branch-specific residual-lane delta mappings associated with state generated uniquely within each branch. The shared-root residual lanes may remain mapped to shared physical storage, while branch-specific residual lanes may be independently released, aliased, compacted, merged, migrated, reconstructed, demoted, or flushed according to branch priority.

A branch-specific residual-lane delta mapping may include a branch identifier, parent-root identifier, branch-local lane descriptor, branch confidence value, branch priority value, tool-use depth, elapsed-time value, or branch success estimate. If a branch is promoted, its branch-specific residual-lane delta mapping may be merged into a canonical mapping or converted into a new shared-root mapping. If a branch is rejected, times out, or is deprioritized, its branch-specific residual-lane storage may be released, migrated, or overwritten without disturbing residual lanes shared by other active branches.

In one mixture-of-experts embodiment, lane-state information may be derived from an expert-routing decision, gate value, sparse expert activation, or expert-output projection. Residual lanes associated with inactive or low-weight experts may be released, compacted, demoted, or reconstructed from shared backing storage, while lanes associated with selected experts may remain in a higher-bandwidth tier.

In one state-space model embodiment, lane-state information may be derived from a scan state, state projection, channel-mixing operation, recurrent transition, or low-rank state update. The memory controller 130 may compact channels having sparse or low-variance state, alias lanes corresponding to dependent state components, or migrate slowly varying state components to a lower-bandwidth tier.

In one multimodal embodiment, lane-state information may identify residual lanes associated with visual, acoustic, language, tactile, sensor, or cross-modal fusion components. The memory controller 130 may prioritize lanes associated with a currently active modality, safety-critical modality, or high-confidence fusion component, while releasing, compacting, aliasing, or migrating lanes associated with inactive or low-priority modalities.

In one training embodiment, the disclosed remapping may reduce activation-memory burden, checkpointing footprint, optimizer-state movement, or rematerialization cost. For example, during a forward pass, residual lanes that are zeroed, masked, linearly dependent, reconstructible, or low-priority may be released, aliased, merged, compacted, or migrated before the corresponding activations are stored for use during a backward pass. During a backward pass, the logical residual representation may be reconstructed from the second lane-to-address mapping 400 when needed for gradient computation, checkpoint replay, or rematerialization. In some embodiments, the controller selects a remapping action based on a training-phase policy that accounts for expected backward reuse, gradient sensitivity, reconstruction cost, and checkpoint fidelity.

In some embodiments, a training pipeline is configured to intentionally produce residual-lane structure that is favorable to later hardware remapping. The training pipeline may include one or more remappability objectives, including a zero-lane objective, sparsity objective, low-rank objective, lane-dependence objective, reconstructability objective, entropy-reduction objective, lane-priority separation objective, aliasability objective, mergeability objective, or tier-demotability objective. Such objectives may be combined with conventional task loss so that the trained model maintains task performance while exposing residual-lane relationships that a memory controller can exploit at inference time.

In some embodiments, the training pipeline receives feedback from the memory controller 130 or a simulator of the memory controller 130. Feedback may include remapping frequency, memory saved, bandwidth avoided, reconstruction cost, fallback frequency, lane reconstruction error, latency impact, or accuracy impact. The training pipeline may adjust model weights, masks, projections, gating structures, regularization terms, adapter layers, or routing structures to increase the fraction of residual lanes that can be released, aliased, merged, compacted, migrated, or reconstructed under a target hardware policy.

### II. Methods for Dynamic Memory Remapping of Residual Lanes in Neural Networks

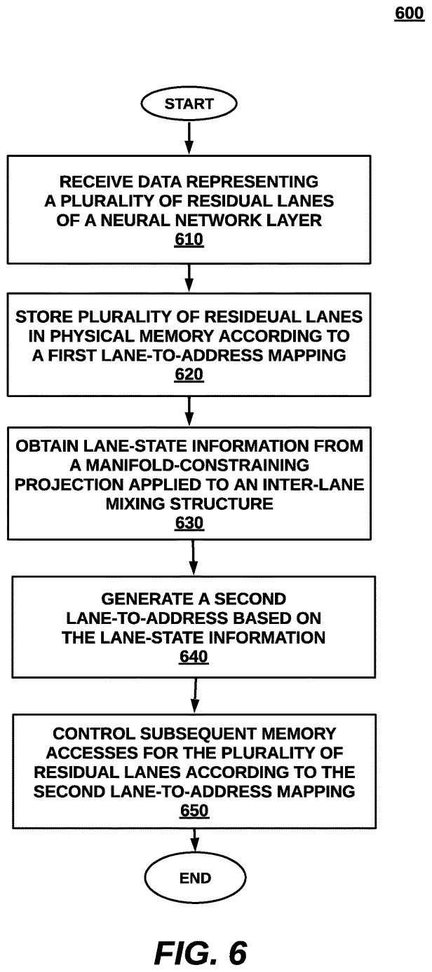

Referring to FIG. 6, a method 600 for dynamic memory remapping of residual lanes in neural networks, according to one embodiment begins at step 610, in which data representing a plurality of residual lanes of a neural-network layer is received. The plurality of residual lanes may correspond to channels, dimensions, slices, partitions, grouped feature sets, or other logical subdivisions of an intermediate neural-network representation.

At step 620, the plurality of residual lanes is stored in physical memory according to a first lane-to-address mapping. The first lane-to-address mapping may represent an initial, dense, default, static, or otherwise pre-remapping relationship between logical residual lanes and physical memory addresses.

At step 630, lane-state information is obtained from a manifold-constraining projection applied to an inter-lane mixing structure. The lane-state information identifies at least one lane relationship among the plurality of residual lanes, including, for example, a zeroed lane, masked lane, linearly dependent lane, correlated lane, reconstructible lane, low-priority lane, low-variance lane, low-entropy lane, inactive lane, or other relationship indicating that one or more lanes need not continue to receive independent physical storage treatment.

At step 640, a second lane-to-address mapping is generated based on the lane-state information. The second lane-to-address mapping may compact active lanes into a smaller physical region, alias a logical lane to a physical address associated with another lane, merge two or more lanes into a shared backing structure, migrate one or more lanes to a different memory tier, release storage associated with one or more lanes, or perform a combination of such remapping operations.

At step 650, subsequent memory accesses for the plurality of residual lanes are controlled according to the second lane-to-address mapping. In this manner, downstream neural-network operations may continue to access the plurality of residual lanes through a logical tensor view, while the underlying physical memory arrangement is modified to reduce storage usage, bandwidth consumption, memory movement, power consumption, or related resource burdens.

In some embodiments, the method further includes reconstructing a logical residual representation for a downstream operation from remapped physical storage.

It will be appreciated that the methods described herein are illustrative and not limiting. The steps of the disclosed methods may be performed in any suitable order, and in some embodiments, one or more steps may be omitted, combined, repeated, or performed concurrently. Additional steps may be included without departing from the scope of the present disclosure. Further, individual steps may be implemented using one or more processing components, modules, or distributed systems, and may be carried out in hardware, software, or any combination thereof. Accordingly, the particular sequencing and grouping of steps described herein are provided for clarity of explanation and are not intended to require strict adherence in all embodiments.

### III. Generalities

In some embodiments, a non-transitory computer-readable medium stores instructions that, when executed by one or more processors or controllers, cause performance of any of the operations described herein.

The foregoing description of embodiments of the present disclosure has been presented for purposes of illustration and description and is not intended to be exhaustive or to limit the disclosure to the precise forms disclosed. Many modifications, variations, and alternative implementations will be apparent to those of ordinary skill in the art in light of the above teachings. For example, although certain embodiments describe transformer residual streams and accelerator-local memory, the disclosed systems and methods may be applied to other model architectures, processor types, memory hierarchies, distributed memory systems, or runtime environments while preserving the core relationship between lane-state information, physical storage treatment, and logical tensor reconstruction.

Therefore, the scope of the invention is defined by the appended claims and their equivalents, rather than by the specific embodiments described herein.

I claim:

1. A computing system comprising:
a memory;
a processor; and
a memory controller configured to:
receive data representing a plurality of residual lanes of a neural-network layer;
store the plurality of residual lanes in physical memory according to a first lane-to-address mapping;
obtain, from a manifold-constraining projection applied to an inter-lane mixing structure, lane-state information identifying at least one lane relationship among the plurality of residual lanes;
generate, based on the lane-state information, a second lane-to-address mapping that at least one of compacts, aliases, merges, migrates, or releases physical storage associated with one or more of the residual lanes; and
control subsequent memory accesses for the plurality of residual lanes according to the second lane-to-address mapping.

2. The computing system of claim 1, wherein the at least one lane relationship comprises a linear dependence between a first residual lane and a second residual lane, and wherein generating the second lane-to-address mapping comprises releasing physical storage allocated to the second residual lane and aliasing a logical address of the second residual lane to a physical address associated with the first residual lane.

3. The computing system of claim 1, wherein the at least one lane relationship indicates that a particular residual lane is zeroed or below a threshold magnitude, and wherein generating the second lane-to-address mapping comprises releasing physical storage associated with the particular residual lane and satisfying a subsequent read request for the particular residual lane without reading released physical storage.

4. The computing system of claim 1, wherein the inter-lane mixing structure comprises an output projection of an attention block, a feed-forward projection, a bottleneck layer, a pruning operator, a learned mask, a gating structure, or a low-rank transform.

5. The computing system of claim 1, wherein the manifold-constraining projection indicates that fewer than all of the plurality of residual lanes contribute independent information to a downstream computation.

6. The computing system of claim 1, wherein generating the second lane-to-address mapping comprises compacting a plurality of sparse or active residual lanes into a contiguous physical memory region.

7. The computing system of claim 1, wherein generating the second lane-to-address mapping comprises merging physical storage treatment of a plurality of logically distinct residual lanes into a shared backing structure.

8. The computing system of claim 1, wherein migrating physical storage associated with the one or more residual lanes comprises moving data corresponding to the one or more residual lanes from a first memory tier having a first bandwidth to a second memory tier having a second bandwidth lower than the first bandwidth based on a priority metric derived from the lane-state information.

9. The computing system of claim 1, wherein the lane-state information comprises at least one of a bitmap, indirection table, descriptor, transform identifier, priority score, or confidence value.

10. The computing system of claim 1, wherein controlling subsequent memory accesses comprises reconstructing at least one requested logical residual lane using one or more of alias resolution, zero insertion, transform-based derivation, or retrieval from an alternate memory tier.

11. The computing system of claim 1, wherein the memory controller is further configured to determine whether to apply the second lane-to-address mapping based on at least one of a memory-capacity condition, bandwidth-pressure condition, thermal condition, fragmentation metric, latency target, or confidence threshold.

12. The computing system of claim 1, wherein the lane-state information is generated based on one or more of runtime statistics, correlation scores, covariance measures, variance measures, entropy measures, norm values, singular value estimates, or reconstruction error criteria.

13. A method comprising:
receiving, by a memory controller, data representing a plurality of residual lanes of a neural-network layer;
storing the plurality of residual lanes in physical memory according to a first lane-to-address mapping;
obtaining, from a manifold-constraining projection applied to an inter-lane mixing structure, lane-state information identifying at least one lane relationship among the plurality of residual lanes;
generating, based on the lane-state information, a second lane-to-address mapping that at least one of compacts, aliases, merges, migrates, or releases physical storage associated with one or more of the residual lanes; and
controlling subsequent memory accesses for the plurality of residual lanes according to the second lane-to-address mapping.

14. A method for hardware-level enforcement of artificial-intelligence (AI) safety constraints, the method comprising:
receiving, at a memory controller, data representing a plurality of residual lanes of a neural-network layer;
obtaining a risk state associated with at least one residual lane of the plurality of residual lanes;
generating, based on the risk state, a security-constrained physical memory mapping for the at least one residual lane, wherein the security-constrained physical memory mapping isolates or restricts physical access to the at least one residual lane relative to a trusted residual lane; and
controlling subsequent memory requests from a downstream execution unit according to the security-constrained physical memory mapping to prevent unauthorized downstream use of the at least one residual lane.

15. The method of claim 14, wherein the risk state is obtained from an AI safety classifier, guardrail module, or policy engine, and indicates that the at least one residual lane contains an unsafe feature, hallucination risk, or untrusted content.

16. The method of claim 14, wherein generating the security-constrained physical memory mapping comprises mapping the at least one residual lane to a protected memory region that is accessible to a verification block but inaccessible to a downstream generation block.

17. The method of claim 14, wherein isolating or restricting physical access comprises preventing the at least one residual lane from aliasing, merging, or sharing a physical backing structure with the trusted residual lane.

18. The method of claim 14, wherein generating the security-constrained physical memory mapping comprises releasing physical storage allocated to the at least one residual lane and returning a generated neutral value or zero value in response to a subsequent read request from the downstream execution unit.

19. The method of claim 14, wherein controlling subsequent memory requests according to the security-constrained physical memory mapping is performed at the hardware level prior to a downstream token-generation, tool-use, or action-selection operation.

20. The method of claim 14, wherein the memory controller evaluates a security domain or tenant identifier associated with the risk state to prevent cross-tenant leakage between the at least one residual lane and the trusted residual lane.
